(19) United States
(12) Patent Application Publication
(10) Pub. No.: US 2010/0057455 A1
(43) Pub. Date: Mar. 4, 2010

(54) Method and System for 3D Lip-Synch Generation with Data-Faithful Machine Learning

(76) Inventors: Ig-Jae Kim, Seoul (KR); Hyeong-Seok Ko, Seoul (KR)

Correspondence Address: PARK LAW FIRM, 3255 WILSHIRE BLVD, SUITE 1110, LOS ANGELES, CA, 90010, US

(21) Appl. No.: 12/198,720

(22) Filed: Aug. 26, 2008

(51) Int. Cl. G10L 15/26

(52) U.S. Cl. 704/235; 704/E15.001

(57) ABSTRACT

A method for generating three-dimensional speech animation is provided using data-driven and machine learning approaches. It utilizes the most relevant part of the captured utterances for the synthesis of input phoneme sequences. If highly relevant data are missing or lacking, then it utilizes less relevant (but more abundant) data and relies more heavily on machine learning for the lip-synch generation.

### BACKGROUND OF THE INVENTION

### Introduction

It is estimated that two thirds of all human brain activity is spent on controlling the movements of the mouth and hands. Some other species, in particular primates, are capable of quite sophisticated hand movements. In terms of mouth movements, however, no other creature can match the human ability to coordinate the jaw, facial tissue, tongue, and larynx, to generate the gamut of distinctive sounds that form the basis of intelligent verbal communication. No less than such pronouncing capability, people have keen eyes to recognize inconsistencies between the voice and corresponding mouth movements. Therefore, in the production of high quality character animations, often a large amount of time and effort is devoted to achieving accurate lip-synch, that is, synchronized movements of mouth associated with a given voice input. The present invention is on 3D lip-synch generation.

Animation of human faces has drawn attention from numerous researchers. Nevertheless, as yet no textbook-like procedure for generating lip-synch has been established. Researchers have been taking data-driven approaches, as well as keyframing and physics-based approaches. Recently, Ezzat et al. [EGP02] made remarkable progress in lip-synch generation using a machine learning approach. In the present work we extended method to 3D, and (2) we improved the dynamic quality of lip-synch by increasing the utilization of corpus data.

Machine learning approaches preprocess captured corpus utterances to extract several statistical parameters that may represent the characteristics of the subject's pronunciation. In their method, Ezzat et al. [EGP02] extracted the mean and variance of the mouth shape, for each of 46 distinctive phonemes. When a novel utterance is given in the form of a phoneme sequence, in the simplest formulation, a naive lip-synch animation can be generated by concatenating the representative mouth shapes corresponding to each phoneme, with each mouthshape being held for a time corresponding to the duration of its matching phoneme. However, this approach produces a static, discontinuous result. An interesting observation of Ezzat et al. [EGP02] was that the variances can be utilized to produce a co-articulation effect. Their objective function was formulated so that the naive result can be modified into a smoother version, with the variance controlling the allowance for the modification. They referred to this sort of minimization procedure as “regularization”. The above rather computation-oriented approach could produce realistic lip-synch animations.

Despite the promising results obtained using the above approach, however, lip-synch animations generated using heavy regularization may have a somewhat mechanical look because the result of optimization in the mathematical parameter space may not necessarily coincide with the coarticulation of human speech. A different approach that does not suffer from this shortcoming is the data-driven approach. Under this approach, a corpus utterance data set is first collected that presumably covers all possible co-articulation cases. Then, in the preprocessing step, the data is annotated in terms of tri-phones. Finally, in the speech synthesis step, for a given sequence of phonemes, a sequence of tri-phones is formed and the database is searched for the video/animation fragments. Since the lip-synch is synthesized from real data, in general the result is realistic. Unfortunately this approach has its own problems: (1) it is not easy to form a corpus of a reasonable size that covers all possible co-articulation cases, and (2) the approach has to resolve cases for which the database does not have any data for a tri-phone or when the database has multiple recordings for the same tri-phone.

### SUMMARY OF THE INVENTION

The present invention contrives to solve the disadvantages of the prior art.

An object of the invention is to provide a method for generating a three-dimensional lip-synch with data-faithful machine learning.

Another object of the invention is to provide a method for generating a three-dimensional lip-synch, in which instantaneous mean and variance for calculating weights for linear combination of expression basis.

An aspect of the invention provides a method for generating three-dimensional lip-synch with data-faithful machine learning.

The method comprises steps of: providing an expression basis, a set of pre-modeled facial expressions, wherein the expression basis is selected by selecting farthest-lying expressions along a plurality of principal axes and then projecting them onto the corresponding principal axes, wherein the principal axes are obtained by a principal component analysis (PCA); providing an animeme corresponding to each of a plurality of phonemes, wherein the animeme comprises a dynamic animation of the phoneme with variations of the weights y(t); receiving a phoneme sequence; loading at least one animeme corresponding to each phoneme of the received phoneme sequence; calculating weights for a currently considered phoneme out of the received phoneme sequence by minimizing an objective function with a target term and a smoothness term, wherein the target term comprises an instantaneous mean and an instantaneous variance of the currently considered phoneme; and synthesizing new facial expressions by taking linear combinations of one or more expressions within the expression basis with the calculated weights.

The step of loading at least one animeme may comprise a step of finding a bi-sensitive animeme for the currently considered phoneme, and the bi-sensitive animeme may be selected by considering two matching other phonemes proceeding and following the currently considered phoneme immediately.

The step of finding the bi-sensitive animeme may comprise a step taking average and variance of occurrences of phonemes having matching proceeding and following phonemes.

When the bi-sensitive animeme is not found the step of loading at least one animeme further may comprise a step of finding a uni-sensitive animeme for the currently considered phoneme, and the uni-sensitive animeme may be selected by considering one matching phoneme out of two other phonemes proceeding or following the currently considered phoneme immediately.

The step of finding the uni-sensitive animeme may comprise a step taking average and variance of occurrences of phonemes having only one of a matching proceeding or following phoneme.

When the uni-sensitive animeme is not found the step of loading at least one animeme further may comprise a step of finding a context-insensitive animeme for the currently considered phoneme, and the context-insensitive animeme may be selected by considering all the phoneme in the phoneme sequence.

The step of finding a context-insensitive animeme may comprise a step of taking average and variance of all occurrences of phonemes in the phoneme sequence.

The step of calculating weights may comprise a step of calculating weights y(t)=(β(t)) over time t for the currently considered phoneme, where β(t) is weights for components of the expression basis.

The step of calculating weights y(t)=(α(t),β(t)) may comprise a step of minimizing an objective function

E^{l}=(y(t)−μₜ)^{T}D^{T}Vₜ⁻¹D(y(t)+λy(t)^{T}W^{T}Wy(t). (2)

where D is a phoneme length weighting matrix, which emphasizes phonemes with shorter durations so that the objective function is not heavily skewed by longer phonemes, μₜ represents a viseme (the most representative static pose) of the currently considered phoneme, Vₜ is a diagonal variance matrix for each weight, and W is constructed so that y(t)^{T}W^{T}Wy(t) penalizes sudden fluctuations in y(t).

The μₜ may be obtained by first taking the instantaneous mean of (α,β) over the phoneme duration, and then taking an average of the means for a proceeding phoneme and a following phoneme.

The step of minimizing may comprise a step of normalizing a duration of the currently considered phoneme to [0, 1].

The step of minimizing may further comprise a step of fitting the weights y(t) with a fifth degree of polynomial with six coefficients.

The method may further comprise, prior to the step of providing an expression basis, steps of: capturing a corpus utterances of a person; and converting the captured utterances into speech data and three-dimensional image data.

The advantages of the present invention are: (1) the method for generating a three-dimensional lip-synch obtain generates lip-synchs of different qualities depending on the availability of the data; and (2) the method for generating a three-dimensional lip-synch produces more realistic lip-synch animation.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a graph illustrating weight of a basis element in uttering “I'm free now”; and

FIG. 2 is a flow chart illustrating the method according to the invention.

### DETAILED DESCRIPTION OF THE INVENTION

A 3D lip-synch technique that combines the machine learning and data-driven approaches is provided. The overall framework is similar to that of Ezzat et al. [EGP02], except it is in 3D rather than 2D. A major distinction between our work and that of Ezzat et al. is that the proposed method makes more faithful utilization of captured corpus utterances whenever there exist relevant data. As a result, it produces more realistic lip-synchs. When relevant data are missing or lacking, the proposed method turns to less-specific (but more abundant) data and uses the regularization to a greater degree in producing the co-articulation. The method dynamically varies the relative weights of the data-driven and the smoothing-driven terms, depending on the relevancy of the available data. By using regularization to compensate for deficiencies in the available data, the proposed approach does not suffer from the problems associated with data-driven approaches.

Section 2 reviews previous work on speech animation. Section 3 summarizes the preprocessing steps that must done before lip-synch generation is performed. Our main algorithm is presented in Section 4. Section 5 describes our experimental results, and Section 6 concludes the description partially.

### 1. Related Work

The previous research on speech animation can be divided into four categories, namely phoneme-driven, physics-based, data-driven, and machine learning approaches. Under the phoneme-driven approach [CM93, GB96, CMPZ02, KP05], animators achieve co-articulation by predefining a set of key mouth shapes and employing an empirical coarticulation model to join them smoothly. In the physics-based approach [Wat87, TW90, LTW95, SNF05], muscle models are built and speech animations are generated based on muscle actuation. The technique developed in the present work is based on real data, and is therefore not directly related to the above two approaches.

Data-driven methods generate speech animation basically by pasting together sequences of existing utterance data. Bregler et al. [BCS97] constructed a tri-phone annotated database and used it synthesize lip-synch animations. Specifically, when synthesizing the lip-synch of a phoneme, they searched the database for occurrences of the tri-phone and then selected a best match, an occurrence that seamlessly connects to the previously generated part. Kshirsagar and Thalmann [KT03] noted that the degree of co-articulation varies during speech, in particular that coarticulation is weaker during inter-syllable periods than during intra-syllable periods. Based on this idea, they advocated the use of syllables rather than tri-phones as the basic decomposable units of speech, and attempted to generate lipsynch-animation using a syllable annotated database. Chao et al. [CFK04] proposed a new data structure called Anime Graph, which can be used to find longer matching sequences in the database for a given input phoneme sequence.

The machine learning approach [BS94, MKT98, Bra99, EGP02, DLN05, CE05] abstracts a given set of training data into a compact statistical model that is then used to generate lip-synch by computation (e.g., optimization) rather than by searching a database. Ezzat et al. [EGP02] proposed a lip-synch technique based on the so-called multidimensional morphable model (MMM), the details of which will be introduced in Section 4.1. Deng et al. [DLN05] generated the co-articulation effect by interpolating involved visemes. In their method, the relative weights during each transition were provided from the result of machine learning. Chang and Ezzat [CE05] extended [EGP02] to enable the transfer of the MMM to other speakers.

### 2. Capturing and Processing Corpus Utterances

In order to develop a 3D lip-synch technique, we must first capture the corpus utterances to be supplied as the training data, and convert those utterances into 3D data. This section presents the details of these preprocessing steps.

### 3.1. Corpus Utterance Capturing

We captured the (speaking) performance of an actress using a Vicon optical system. Eight cameras tracked 66 markers attached to her face (7 were used to track the gross motion the head) at a rate of 120 frames per second. The total duration of the motion capture was 30, 000 frames. The recorded corpus consisted of 1-syllable and 2-syllable words as well as short and long sentences. The subject was asked to utter them in a neutral expression.

### 2.2. Speech and Phoneme Alignment

Recorded speech data need to be phonetically aligned so that a phoneme is associated with the corresponding (utterance) motion segment. We performed this task using the CMU Sphinx system [HAH93], which employs a forced Viterbi search to find the optimal start and end points of each phoneme. This system produced accurate speaker-independent segmentation of the data.

### 3.3. Basis Selection

We use the blendshape technique for the generation of facial expressions in 3D [CK01, JTD03]. To use this technique, we must first select a set of pre-modeled expressions referred to as the expression basis. Then, by taking linear combinations of the expressions within the expression basis, we can synthesize new expressions.

The expressions comprising the expression basis must be selected carefully so that they span the full range of captured corpus utterances. Ezzat et al. [EGP02] selected the elements of the basis based on the clustering behavior of the corpus data; they applied k-means clustering [Bis95] using the Mahalanobis distance as the internal distance metric. Instead of the clustering behavior, Chuang and Bregler [CB05] looked at the scattering behavior of the corpus data in the space formed by the principal components determined by principal component analysis (PCA). Specifically, as the basis elements, they selected the expressions that lay farthest along each principal axis. They found that this approach performed slightly better than that of Ezzat et al. [EGP02], since it can be used to synthesize extreme facial expressions that may not be covered by the cluster-based basis.

Here we use a modified version of the approach of Chuang and Bregler [CB05] to select the basis. Specifically, after selecting the farthest-lying expressions along the principal axes, we then project them onto the corresponding principal axes. This additional step increases the coverage (and thus increases the accuracy of the synthesis), since the projection removes linear dependencies that may exist in unprotected expressions.

### 3.4 Internal Representation of Corpus Utterances

Internal representation of the corpus utterances is performed by, for each frame of the corpus, finding weights of the basis expressions that minimize the difference between the captured expression and the linear combination. We used quadratic programming for this minimization. Use of this internal representation means the task of lip-synch generation is reduced to finding a trajectory in an N-dimensional space, where N is the size of the expression basis.

### 3. Data-Faithful Lip-Synch Generation

Even though our lip-synch generation is done in 3D, it is branched from the excellent work of Ezzat et al. [EGP02]. So, we first summarize the main features of [EGP02], and then present the novel elements introduced in the present work.

### 4.1. Trainable Speech Animation Revisited

Ezzat et al. [EGP02] proposed an image-based videorealistic speech animation technique based on machine learning. They introduced the MMM, which synthesizes facial expressions from a set of 46 prototype images and another set of 46 prototype optical flows. The weights (α,β)=(α1, . . . ,α46, β1, . . . ,β46) of these 92 elements are regarded as the coordinates of a point in MMM-space. When a point is given in MMM-space, the facial expression is synthesized by first calculating the image-space warp with the weights (α1, . . . ,α46), then applying the warp to 46 prototype images, and finally generating the linear combination of the warped images according to (β1, . . . ,β46).

With the MMM, the task of generating a lip-synch is reduced to finding a trajectory y(t)=(α(t),β(t)) which is defined over time t. For a given phoneme sequence, [EGP02] finds y(t) that minimizes the following objective function

$$E = \underbrace{{( y ( t ) - μ )}^{T} {D}^{T} {V}^{- 1} D ( y ( t ) - μ )}_{target term} + λ \underbrace{y {( t )}^{T} {W}^{T} Wy ( t )}_{smoothness term} , \qquad ( 1 )$$

where D is the phoneme length weighting matrix, which emphasizes phonemes with shorter durations so that the objective function is not heavily skewed by longer phonemes. In the above equation, μ represents the viseme (the most representative static pose) of the currently considered phoneme. For visual simplicity, Equation 1 uses μ, D, and Σ without any subscript. In fact, they represent the (discretely) varying quantities for the phonemes uttered during Ω. If φ¹, . . . , φ^{L} are the phonemes uttered, and if Ω¹, . . . ,Ω^{L} are the durations of those phonemes, respectively, then the detailed version of Equation 1 can be written as E=Σᵢ₌₁^{L}[y(t)−μⁱ)^{T}D^{iT}(Vⁱ)⁻¹Dⁱ(y(t)−μ^{l})]+λy(t)^{T}W^{T}Wy(t), where μ, Dⁱ, and Vⁱ represent the mean, phoneme length weighting matrix, and variance taken over Ωⁱ, respectively.

For a phoneme, μ is obtained by first taking the mean of (α,β) over the phoneme duration, and then taking the average of those means for all occurrences of the phoneme in the corpus. V is the 46×46 (diagonal) variance matrix for each weight. Thus, if the smoothness term had not been included in the objective function, the minimization would have produced a sequence of static poses, each lasting for the duration of the corresponding phoneme. The co-articulation effect is produced by the smoothness term; The matrix W is constructed so that y(t)^{T}W^{T}Wy(t) penalizes sudden fluctuations in y(t), and the influence of this smoothness term is amplified when there is more uncertainty (i.e., when Σ is large). As pointed out by Ezzat et al. [EGP02], the above method tends to create under-atriculated results because using a flat mean μ during the phoneme duration tends to average out the mouth movement. To alleviate this problem, they additionally proposed the use of gradient descent learning that refines the statistical model by iteratively minimizing the difference between the synthetic trajectories and real trajectories. However, this postprocessing can be applied only to a limited portion of the corpus (i.e, the part covered by the real data).

### 4.2. Animeme-Based Synthesis

Our current work was motivated by the belief that by abstracting all the occurrences of a phoneme in the corpus into a flat mean μ and a variance Σ, the method of Ezzat et al. [EGP02] underutilizes the given corpus utterances. We hypothesized that the above method could be improved by increasing the data utilization. One way to increase the utilization is to account for the variations in α and β over time. Since the conventional viseme model cannot represent such variations, we use a new model called the animeme to represent a phoneme. In contrast to a viseme which is the static visualization of a phoneme, an animeme is the dynamic animation of a phoneme.

Now, we describe how we utilize the time-varying part of the corpus utterance data for lip-synch generation. The basic idea is, in finding y(t) with the objective function shown in Equation 1, to take the instantaneous mean μₜ and the instantaneous variance Σₜ at time t. Hence, the new objective function we propose is

E^{l}=(y(t)−μₜ)^{T}D^{T}Vₜ⁻¹D(y(t)−μₜ)+λy(t)^{T}W^{T}Wy(t). (2)

Through this new regularization process, the time-varying parts of the corpus utterances are reflected in the synthesized results. A problem in using Equation 2 is that utterances corresponding to the same phoneme can have different durations. A simple x, which we use in the present work, is to normalize the durations to [0,1]. Careless normalization can produce distortion. To minimize this, when capturing the corpus utterances, we asked the subject to utter all words and sentences at a uniform speed. We note that the maximum standard deviation we observed for any set of utterances corresponding to the same phoneme was 9.4% of the mean duration. Thus, any distortion arising from the normalization would not be severe.

After the temporal normalization, we fit the resulting trajectory with a fifth degree of polynomial, meaning that the trajectory is abstracted into six coefficients. With the above simplifications, we can now straightforwardly calculate μₜ and Σₜ.

### 4.3. Data-Faithful Co-Articulation

The use of time-varying mean and variance retains information that would have been lost if a flat mean and variance had been used. In this section we propose another idea that can further increase the data utilization. The proposed modification is based on the relevancy of the available data. The present invention follows the machine learning framework, works more precisely when we provide more relevant learning input.

Imagine that we are in the middle of generating the lip-synch for a phoneme sequence (φ¹, . . . ,φ^{L}), and that we have to supply μₜ and Vₜⁱ for the synthesis of φⁱ. One approach would be to take the (time-varying) average and variance of all the occurrences of φⁱ in the corpus data, which we call the context-insensitive mean and variance. We note that, even though the context insensitive quantities carry time-varying information, the details may have been smoothed out. This smoothing out takes place because the occurrences, even though they are utterances of the same phoneme, were uttered in different contexts. We propose that taking the average and variance should be done for the occurrences uttered in an identical context. More specifically, we propose to calculate μₜⁱ and Vₜⁱ by taking only the occurrences of φⁱ that are preceded by φⁱ⁻¹ and followed by φⁱ⁺¹. We call such occurrences bi-sensitive animemes. In order for this match to make sense at the beginning and end of a sentence, we regard silence as a (special) phoneme.

By including only bi-sensitive animemes in the calculation of μₜ and Vₜⁱ, the variance tends to have smaller values than is the case for the context-insensitive variance. This means that the bi-sensitive mean μₜⁱ represents situations with a higher certainty, resulting in a reduction in the degree of artificial smoothing that occurs in the regularization. This data-faithful result is achieved by limiting the use of data only to the relevant part.

We note that the above approach can encounter degenerate cases. There may exist insufficient or no bi-sensitive animemes. For cases where there is only a single bi-sensitive animeme, the variance would be zero and hence the variance matrix would not be invertible. And for the cases where there is no bi-sensitive animeme, then the mean and variance would not be available. In such cases, Equation 2 cannot be directly used. In these zero/one-occurrence cases, we propose to take the mean and variance using the uni-sensitive animemes, that is, the occurrences of φⁱ that are preceded by φⁱ⁻¹ but which are not followed by φⁱ⁺¹.

When synthesizing the next phoneme, of course, we go back to using the bi-sensitive mean and variance. If bi-sensitive animemes are also lacking for this new phoneme, we again use the uni-sensitive animemes. If, as occurs in very rare cases, uni-sensitive animemes are also lacking, then we use the context insensitive mean. The collection of uni-sensitive animemes tends to have a large variance towards the end, whereas the bi-sensitive animemes that come next will have a smaller variance. As a result, the artificial smoothing will mostly apply to the preceding phoneme. However, we found that the joining of a uni-sensitive mean and a bi-sensitive mean did not produce any noticeable degradation of quality. We think it is because the bi-sensitive phoneme, which is not modified much, guides the artificial smoothing of the uni-sensitive mean.

Even when there exist two or more occurrences of bi-sensitive animemes, if the number is not large enough, one may regard the situation as uncertain and choose to process the situation in the same way as for the zero/one-occurrence cases. Here, however, we propose taking the bi-sensitive animemes for the mean and variance calculation. The rationale is that, (1) more specic data is better as long as the data are useable, and (2) even when occurrences are rare, if the bi-sensitive animemes occur more than once, the variance has a valid meaning. For example, if two occurrences of bi-sensitive animemes happen to be very close [different], the data can be trusted [less-trusted], but in this case the variance will be small [large] (i.e., the variance does not depend on the data size).

### 4.4. Complete Hierarchy of Data-Driven Approaches

In terms of data utilization, completely-individual data-driven approaches (e.g., lip-synch generation by joining captured video segments) lie at one extreme, while completely-general data-driven approaches (e.g., lip-synch generation with flat means) lie at the other extreme. In this section, we highlight how the proposed method fills in these two extremes. Regularization with bi-sensitive animemes corresponds to using less individual data than completely-individual data, since artificial smoothing is used for the uncertain part (even though the uncertainty in this case is low). The use of uni-sensitive animemes when specific data are lacking corresponds to using more general data, but nevertheless this data is less general than completely-general data.

### 5. Experimental Results

We used the algorithm described in this disclosure to generate lip-synch animations of several words and sentences, and a song, as described below. The method was implemented on a PC with an Intel Pentium 4 3.2 GHz CPU and Nvidia geforce 6800 GPU.

Word Test We generated the lip-synch animation for the recorded pronunciations of “after”, “afraid”, and “ago”. In the accompanying video, the synthesized results are shown with 3D reconstruction of the captured utterances, for side by side comparison. The database had multiple occurrences for the tri-phones appearing in those words; hence the lip-synch was produced with context-sensitive (i.e., bi-sensitive) time-varying means. No differences can be discerned between the captured utterances and synthesized results.

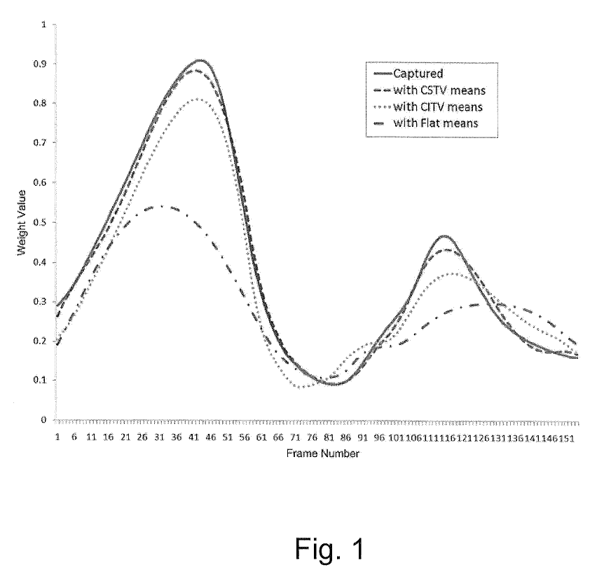

Sentence Test We used the proposed technique to generate animations of the sentences “Don't be afraid” and “What is her age?”. The voice input was obtained from the TTS (Text-To-Speech) of AT&T Lab. In addition, we experimented with the sentence “I'm free now”, for which we had captured data. For this sentence, we generated lip-synchs with context-insensitive time-varying (CITV) means and flat means, as well as with context-sensitive time-varying (CSTV) means. FIG. 1 plots the weight of a basis element during the utterance of the sentence for the three methods. Comparison of the curves reveals that (1) the synthesis with CSTV means is very close to the captured utterance, and (2) the synthesis with CITV means produces less accurate results than the one with CSTV but still more accurate than the one with flat means. Also, we generated a lip-synch animation for the first part of the song “My Heart Will Go On” sung by Celine Dion.

TABLE 1
Comparison of Reconstruction Errors

| case | word#1 | sentence#1 | sentence#2 |
|---|---|---|---|
| CSTV mean | 1.15% | 1.32% | 1.53% |
| CITV mean | 2.53% | 2.82% | 2.91% |
| flat mean | 6.24% | 6.83% | 6.96% |

Comparison of Reconstruction Errors We measured the reconstruction errors in the lip-synch generation of the word “ago”, the sentences “I'm free now” and “I met him two years ago”, which are labelled as word#1, sentence#1, and sentence#2 in Table 1, respectively. The error metric used was

$$γ [ \% ] = 100 \times \frac{\sqrt{{\sum }_{j = 1}^{N} {\vert {v}_{j}^{*} - {v}_{j} \vert}^{2}}}{\sqrt{{\sum }_{j = 1}^{N} {\vert {v}_{j}^{*} \vert}^{2}}} , \qquad ( 3 )$$

where vⱼ and V*ⱼ are the vertex positions of the captured utterance and the synthesized result, respectively. The numbers appearing in Table 1 correspond to the average of γ taken over the word/sentence duration. The error data again show that the proposed technique (i.e., lip-synch with CSTV and CITV means) fills in the gap between the completely-individual data-driven approach and the computation-oriented approaches (flat means) in a predictable way: The greater the amount of relevant data available, the more accurate the results obtained using the proposed technique.

### 6. Conclusion

Some form of lip-synch generation technique must be used whenever a synthetic face speaks, regardless of whether it is in a real-time application or in a high quality animation/movie production. One way to perform this task is to collect a large database of utterance data and paste together sequences of these collected utterances, which is referred to as the data-driven approach. This approach utilizes individual data and hence produces realistic results; however, problems arise when the database does not contain the fragments required to generate the desired utterance. Another way to perform lip-synch generation is to use only basic statistical information such as means and variances and let the optimization do the additional work for the synthesis of co-articulation. This approach is less sensitive to data-availability, but is not faithful to the individual data which are already given.

Given the shortcomings of the data-driven and machine learning approaches, it is surprising that to date no technique has been proposed that provides a middle ground between these extremes. The main contribution of the present work is to propose a hybrid technique that combines the two approaches in such a way that the problems associated with each approach go away. We attribute this success to the introduction of the animeme concept. This simple concept significantly increases the data utilization. Another element of the proposed method that is essential to its success is the inclusion of a mechanism for weighting the available data according to its relevancy, specifically by dynamically varying the weights for the data-driven and smoothing terms. Finally, we note that the new method proposed in this disclosure for the selection of the expression basis was also an important element in producing accurate results.

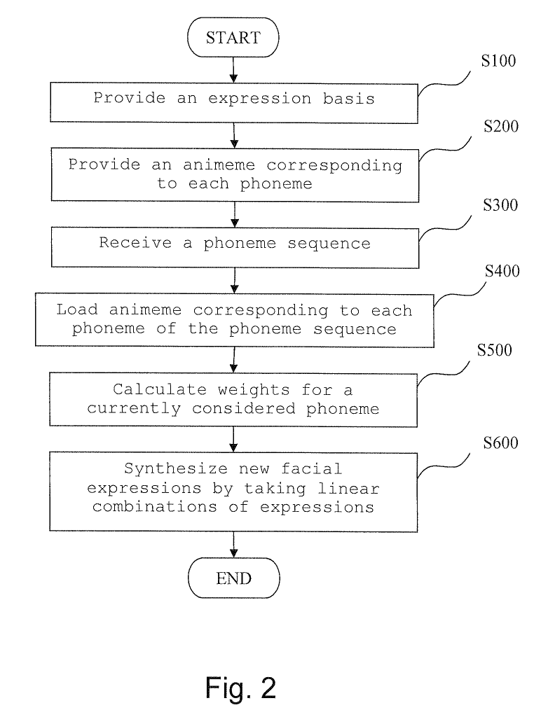

An aspect of the invention provides a method for generating three-dimensional lip-synch with data-faithful machine learning as shown in FIG. 2.

The method comprises steps of: providing an expression basis, a set of pre-modeled facial expressions, wherein the expression basis is selected by selecting farthest-lying expressions along a plurality of principal axes and then projecting them onto the corresponding principal axes, wherein the principal axes are obtained by a principal component analysis (PCA) (S100); providing an animeme corresponding to each of a plurality of phonemes, wherein the animeme comprises a dynamic animation of the phoneme with variations of the weights y(t) (S200); receiving a phoneme sequence (S300); loading at least one animeme corresponding to each phoneme of the received phoneme sequence (S400); calculating weights for a currently considered phoneme out of the received phoneme sequence by minimizing an objective function with a target term and a smoothness term, wherein the target term comprises an instantaneous mean and an instantaneous variance of the currently considered phoneme (S500); and synthesizing new facial expressions by taking linear combinations of one or more expressions within the expression basis with the calculated weights (S600).

The step S400 of loading at least one animeme may comprise a step of finding a bi-sensitive animeme for the currently considered phoneme, and the bi-sensitive animeme may be selected by considering two matching other phonemes proceeding and following the currently considered phoneme immediately.

The step of finding the bi-sensitive animeme may comprise a step taking average and variance of occurrences of phonemes having matching proceeding and following phonemes.

When the bi-sensitive animeme is not found the step of loading at least one animeme further may comprise a step of finding a uni-sensitive animeme for the currently considered phoneme, and the uni-sensitive animeme may be selected by considering one matching phoneme out of two other phonemes proceeding or following the currently considered phoneme immediately.

The step of finding the uni-sensitive animeme may comprise a step taking average and variance of occurrences of phonemes having only one of a matching proceeding or following phoneme.

When the uni-sensitive animeme is not found the step of loading at least one animeme further may comprise a step of finding a context-insensitive animeme for the currently considered phoneme, and the context-insensitive animeme may be selected by considering all the phoneme in the phoneme sequence.

The step of finding a context-insensitive animeme may comprise a step of taking average and variance of all occurrences of phonemes in the phoneme sequence.

The step S500 of calculating weights may comprise a step of calculating weights y(t)=(β(t)) over time t for the currently considered phoneme, where β(t) is weights for components of the expression basis.

The step of calculating weights y(t)=(α(t),β(t)) may comprise a step of minimizing an objective function

E^{l}=(y(t)−μₜ)^{T}D^{T}Vₜ⁻¹D(y(t)−μₜ)+λy(t)^{T}W^{T}Wy(t). (2)

where D is a phoneme length weighting matrix, which emphasizes phonemes with shorter durations so that the objective function is not heavily skewed by longer phonemes, μₜ represents a viseme (the most representative static pose) of the currently considered phoneme, Vₜ is a diagonal variance matrix for each weight, and W is constructed so that y(t)^{T}W^{T}Wy(t) penalizes sudden fluctuations in y(t).

The μt may be obtained by first taking the instantaneous mean of (α, β) over the phoneme duration, and then taking an average of the means for a proceeding phoneme and a following phoneme.

The step of minimizing may comprise a step of normalizing a duration of the currently considered phoneme to [0, 1].

The step of minimizing may further comprise a step of fitting the weights y(t) with a fifth degree of polynomial with six coefficients.

In certain embodiments of the invention, the method may further comprise, prior to the step of providing an expression basis, steps of: capturing a corpus utterances of a person; and converting the captured utterances into speech data and three-dimensional image data.

In certain embodiments of the invention, capturing a corpus utterances may be performed with cameras tracking markers attached to a head of the person. Some of the markers may be used to track a general motion of the head. Each of the cameras may capture images at a rate of at least about 100 frames per second so as to obtain raw image data.

In certain embodiments of the invention, the step of capturing a corpus utterances may comprise a step of recording sentences uttered by the person including 1-syllable and 2-syllable words so as to obtain speech data, and the obtained speech data may be associated with corresponding raw image data. The speech data and the corresponding raw image data may be aligned phonetically. The step of converting may comprise a step of finding optimal start and end points of a phoneme in the speech data.

### REFERENCES

[Bis95] BISHOP, C. M.: Neural Networks for Pattern Recognition. Clarendon Press, Oxford, 1993.
[BCS97] BREGLER, C., COVELL, M. AND SLANEY, M.: Video Rewrite:driving visual speech with audio. In Proceedings of SIGGRAPH 1997, ACM Press, C353- C360.
[Bra99] BRAND, M.: Voice puppetry. In Proceedings of SIGGRAPH 1999, ACM Press, C21-C28.
[BS94] BROOK, N. AND SCOTT, S.: Computer graphics animations of talking faces based on stochastic models. In International Symposium on Speech, Image Processing and Neural Network, IEEE, (1994), C73-C76.
[CE05] CHANG, Y.-J., AND EZZAT, T.: Transferable Videorealistic Speech Animation. In Proceedings of ACM SIGGRAPH/Eurographics Symposium on Computer Animation., (2005), C143-C151.
[CFKP04] CHAO, Y., FALOUTSOS, P., KOHLER, E., AND PIGHIN, F.: Real-time speech motion synthesis from recorded motions. In Proceedings of ACM SIGGRAPH/Eurographics Symposium on Computer Animation., (2004), C347-C355.
[CFKP04] CHAO, Y., FALOUTSOS, P., KOHLER, E., AND PIGHIN, F.: Real-time speech motion synthesis from recorded motions. In Proceedings of ACM SIGGRAPH/Eurographics Symposium on Computer Animation., (2004), C347-C355.
[CK01] CHOE, B. AND KO, H. S.: Analysis and synthesis of facial expressions with hand-generated muscle actuation basis. In proceedings of computer animation, (2001), C12-C19.
[CM93] COHEN, M. AND MASSARO, D.: Modeling coarticualtion in synthetic visual speech. In Models and Techniques in Computer Animation, Springer Verlag (1993), C139-C156.
[CMPZ02] COSI, P., CALDOGNETTO, E. M., PERLIN, G. AND ZMARICH, C.: Labial coarticulation modeling for realistic facial animation. In proceedings of International Conference on Multimodal Interfaces, (2002), C505-C510.
[CB05] CHUANG, E., AND BREGLER, C.: Moodswings: Expressive Speech Animation. In ACM Transaction on Graphics, Vol. 24, Issue 2, 2005.
[DLN05] DENG, Z., LEWIS, J. P., AND NEUMANN, U.: Synthesizing Speech Animation by Learning Compact Speech Co-Articulation Models. In Proceedings of Computer graphics international., IEEE Computer Society Press, (2005), C19-C25.
[EGP02] EZZAT, T., GEIGER, G., AND POGGIO, T.: Trainable videorealistic speech animation. In Proceedings of SIGGRAPH 2002, ACM Press, C388-C398.
[GB96] GOFF, B. L., AND BENOIT, C.: A text-toaudiovisual speech synthesizer for french. In Proceedings of International Conference on Spoken Language Processing 1996, C2163-C2166.
[HAH93] HUANG, X., ALLEVA, F., HON, H. W., HWANG, M. Y., LEE, K. F., AND ROSENFELD, R.: The SPHINX-II speech recognition system: an overview. In Computer Speech and Language 1993, Vol. 7, Num. 2, C137-C148.
[JTD03] JOSHI, P., TIEN, W. C., DESBRUN, M. AND PIGHIN, F.: Learning controls for blendshape based realistic facial animation. In proceedings of ACM SIGGRAPH/Eurographics Symposium on Computer Animation, (2003).
[KP05] KING, S. A., AND PARENT, R. E.: Creating speech-synchronized animation. IEEE Transaction on Visualization and Computer Graphics, Vol. 11, No. 3, (2005), C341-C352.
[KT03] KSHIRSAGAR, S., AND THALMANN, N. M.: Vi-syllable based speech animation. In Computer Graphics Forum, Vol. 22, Num. 3, (2003).
[LTW95] LEE, Y., TERZOPOULOS, D., AND WATERS, K.: Realistic modeling for facial animation. In Proceedings of SIGGRAPH 1995, ACM Press, C55-C62.
[MKT98] MASUKO, T., KOBAYASHI, T., TAMURA, M., MASUBUCHI, J., AND TOKUDA, K.: Text-to-visual speech synthesis based on parameter generation from hmm. In Proceedings of International Conference on Acoustics, Speech and Signal Processing, IEEE, (1998), C3745-C3748.
[Par72] PARKE, F. I.: Computer generated animation of faces. In Proceedings of ACM Conference 1972, ACM Press, C451-C457.
[SNF05] SIFAKIS, E., NEVEROV, I., AND FEDKIW, R.: Automatic determination of facial muscle activations from sparse motion capture marker data. In Proceedings of SIGGRAPH 2005, ACM Press, C417-C425.
[TW90] TERZOPOULOS, D., AND WATERS, K.: Physically-based facial modeling, analysis and animation. The Journal of Visualization and Computer Animation, (1990), C73-C80.
[Wat87] WATERS, K.: A muscle model for animating three-dimensional facial expressions. In Proceedings of SIGGRAPH 1987, ACM Press, C17-C24.

What is claimed is:

1. A method for generating three-dimensional lip-synch with data-faithful machine learning, the method comprising steps of:
providing an expression basis, a set of pre-modeled facial expressions, wherein the expression basis is selected by selecting farthest-lying expressions along a plurality of principal axes and then projecting them onto the corresponding principal axes, wherein the principal axes are obtained by a principal component analysis (PCA);
providing an animeme corresponding to each of a plurality of phonemes, wherein the animeme comprises a dynamic animation of the phoneme with variations of the weights y(t);
receiving a phoneme sequence;
loading at least one animeme corresponding to each phoneme of the received phoneme sequence;
calculating weights for a currently considered phoneme out of the received phoneme sequence by minimizing an objective function with a target term and a smoothness term, wherein the target term comprises an instantaneous mean and an instantaneous variance of the currently considered phoneme; and
synthesizing new facial expressions by taking linear combinations of one or more expressions within the expression basis with the calculated weights.

2. The method of claim 1, wherein the step of loading at least one animeme comprises a step of finding a bi-sensitive animeme for the currently considered phoneme, wherein the bi-sensitive animeme is selected by considering two matching other phonemes proceeding and following the currently considered phoneme immediately.

3. The method of claim 2, wherein the step of finding the bi-sensitive animeme comprises a step taking average and variance of occurrences of phonemes having matching proceeding and following phonemes.

4. The method of claim 2, wherein when the bi-sensitive animeme is not found the step of loading at least one animeme further comprises a step of finding a uni-sensitive animeme for the currently considered phoneme, wherein the uni-sensitive animeme is selected by considering one matching phoneme out of two other phonemes proceeding or following the currently considered phoneme immediately.

5. The method of claim 4, wherein the step of finding the uni-sensitive animeme comprises a step taking average and variance of occurrences of phonemes having only one of a matching proceeding or following phoneme.

6. The method of claim 4, wherein when the uni-sensitive animeme is not found the step of loading at least one animeme further comprises a step of finding a context-insensitive animeme for the currently considered phoneme, wherein the context-insensitive animeme is selected by considering all the phoneme in the phoneme sequence.

7. The method of claim 6, wherein the step of finding a context-insensitive animeme comprises a step of taking average and variance of all occurrences of phonemes in the phoneme sequence.

8. The method of claim 1, wherein the step of calculating weights comprises a step of calculating weights y(t)=(β(t)) over time t for the currently considered phoneme, where β(t) is weights for components of the expression basis.

9. The method of claim 8, wherein the step of calculating weights y(t)=(α(t),β(t)) comprises a step of minimizing an objective function
E^{l}=(y(t)−μₜ)^{T}D^{T}Vₜ⁻¹D(y(t)−μₜ)+λy(t)^{T}W^{T}Wy(t). (2)
where D is a phoneme length weighting matrix, which emphasizes phonemes with shorter durations so that the objective function is not heavily skewed by longer phonemes, μₜ represents a viseme (the most representative static pose) of the currently considered phoneme, Vₜ is a diagonal variance matrix for each weight, and W is constructed so that y(t)^{T}W^{T}Wy(t) penalizes sudden fluctuations in y(t).

10. The method of claim 9, wherein μₜ is obtained by first taking the instantaneous mean of (α, β) over the phoneme duration, and then taking an average of the means for a proceeding phoneme and a following phoneme.

11. The method of claim 9, wherein the step of minimizing comprises a step of normalizing a duration of the currently considered phoneme to [0, 1].

12. The method of claim 11, wherein the step of minimizing further comprises a step of fitting the weights y(t) with a fifth degree of polynomial with six coefficients.

13. The method of claim 1, further comprising, prior to the step of providing an expression basis, steps of:
capturing a corpus utterances of a person; and
converting the captured utterances into speech data and three-dimensional image data.
